(19) United States
(12) Patent Application Publication
(10) Pub. No.: US 2016/0215201 A1
(43) Pub. Date: Jul. 28, 2016

(54) COMPOSITION AND METHOD FOR ENHANCED HYDROCARBON RECOVERY

(71) Applicants: SHELL OIL COMPANY, Houston, TX (US); WILLIAM MARSH RICE UNIVERSITY, Houston, TX (US)

(72) Inventors: Julian Richard BARNES, Amsterdam (NL); Clarence Alphonso MILLER, Houston, TX (US); George Jiro HIRASAKI, Bellaire, TX (US); Maura Camps PUERTO, Houston, TX (US); Sheila Teresa DUBEY, Sugar Land, TX (US); Carmen Geraldine REZNIK, Friendswood, TX (US)

(21) Appl. No.: 15/024,421

(22) PCT Filed: Sep. 24, 2014
(86) PCT No.: PCT/US2014/057231

§ 371 Date: Mar. 24, 2016

Related U.S. Application Data
(60) Provisional application No. 61/882,913, filed on Sep. 26, 2013.

(51) Int. Cl. C09K 8/584

(52) U.S. Cl. CPC C09K 8/584

(57) ABSTRACT

The invention relates to a hydrocarbon recovery composition, which composition contains: a) a first anionic surfactant which is selected from the group consign of a propoxylated primary alcohol carboxylate or a propoxylated primary alcohol glycerol sulfonate; and b) a second anionic surfactant which is an alkoxylated primary alcohol carboxylate or an alkoxylated primary alcohol glycerol sulfonate selected from the group consisting of (i) an ethoxylated primary alcohol carboxylate, (ii) an ethoxylated-propoxylated primary alcohol carboxylate, (iii) an ethoxylated primary alcohol glycerol sulfonate and (iv) an ethoxylated-propoxylated primary alcohol glycerol sulfonate. Further, the invention relates to an injectable liquid containing the hydrocarbon recovery composition and a method for treating a hydrocarbon containing formation.

This present application claims the benefit of U.S. Patent Application No. 61/882,913 filed Sep. 26, 2013.

### FIELD OF THE INVENTION

The present invention relates to a hydrocarbon recovery composition, injectable liquids containing the hydrocarbon recovery composition, and a method for treating hydrocarbon containing formations.

### BACKGROUND TO THE INVENTION

Hydrocarbons, such as crude oil, may be recovered from hydrocarbon containing formations (or reservoirs) by penetrating the formation with one or more wells, which may allow the hydrocarbons to flow to the surface. A hydrocarbon containing formation may have a natural energy source (e.g. gas, water) to aid in mobilizing hydrocarbons to wells at the surface. For example, water or gas may be present in the formation at sufficient levels to exert pressure on the hydrocarbons and mobilize them to the surface of the production wells. Reservoir conditions (e.g. permeability, hydrocarbon concentration, porosity, temperature, pressure) can significantly impact the economic viability of hydrocarbon production from any particular hydrocarbon containing formation. Natural energy sources that exist may become depleted over time, often long before the majority of hydrocarbons have been extracted from the reservoir. Therefore, supplemental recovery processes may be required and used to continue the recovery of hydrocarbons from the hydrocarbon containing formation. Examples of known supplemental processes include waterflooding, polymer flooding, alkali flooding, thermal processes, solution flooding or combinations thereof.

In recent years there has been increased activity in developing new and improved methods of chemical Enhanced Oil Recovery (cEOR) for maximizing the yield of hydrocarbons from a subterranean reservoir. In surfactant EOR the mobilization of residual oil saturation is achieved through surfactants which generate a sufficiently (ultra) low crude oil/water interfacial tension (IFT) to give a capillary number large enough to overcome capillary forces and allow the oil to flow (Chatzis & Morrows, “Correlation of capillary number relationship for sandstone”, SPE Journal, vol. 29, p. 555-562, 1989). Because different reservoirs can have very different characteristics (e.g. crude oil type, temperature, water composition—salinity, hardness etc.), and therefore, it is desirable that the structures and properties of the added surfactant(s) be matched to the particular conditions of a reservoir to achieve the required low IFT. In addition, a promising surfactant must fulfil other important criteria such as low rock retention or adsorption, compatibility with polymer, thermal and hydrolytic stability and acceptable cost (including ease of commercial scale manufacture).

Compositions and methods for EOR are described in U.S. Pat. No. 3,943,160, U.S. Pat. No. 3,946,812, U.S. Pat. No. 4,077,471, U.S. Pat. No. 4,216,079, U.S. Pat. No. 5,318,709, U.S. Pat. No. 5,723,423, U.S. Pat. No. 6,022,834, U.S. Pat. No. 6,269,881 and “Low Surfactant Concentration Enhanced Waterflooding”, Wellington et al., Society of Petroleum Engineers, 1995.

Compositions and methods for EOR utilizing internal olefin sulfonates (IOSs) are known, e.g. from U.S. Pat. No. 4,597,879. The compositions described in the foregoing patent have the disadvantages that both brine solubility and divalent ion tolerance are insufficient under certain reservoir conditions. U.S. Pat. No. 4,979,564 describes the use of IOSs in a method for EOR using low tension viscous waterflood. An example of a commercially available material described as being useful was ENORDET® IOS 1720, a product of Shell Oil Company identified as a C₁₇₋₂₀ internal olefin sulfonate sodium salt. This material has a low degree of branching. U.S. Pat. No. 5,068,043 describes a petroleum acid soap-containing a surfactant system for waterflooding wherein a cosurfactant comprising a C₁₇₋₂₀ or a C₂₀₋₂₄ IOS was used.

A key feature of successful surfactant formulations for cEOR is solubility of the surfactant(s) in the requisite injection fluid, typically an aqueous brine. Surfactants or blends thereof that are not soluble will form precipitates. Surfactants that precipitate will be effectively lost and will not be available for interaction with the crude oil. In addition, the precipitated surfactants can plug a reservoir and hazy injection solutions will give increased surfactant losses related to adsorption as the aqueous solution propagates through the reservoir. A challenging regime in which to achieve satisfactory aqueous solubility is with high salinity, hard brine formulations (i.e. an injection fluid containing high ionic concentration of divalent cations, particularly calcium and magnesium). A brine with ionic composition equivalent to that of sea water (and higher) with these divalent ions is an example of such systems.

Medium to high salinity formulations (>2 wt % total dissolved solids) traditionally require an IOS surfactant in order to achieve good performance at these salinities and in combination with the crude oil. However, it has been found that in the presence of higher concentrations of divalent cations, IOS based surfactants form unacceptable, hazy solutions and even have been found to precipitate in the presence of these divalent cations.

Generally, solvents, such as sec-butanol, isopropanol, tert-amyl alcohol and others, also referred to as “co-solvents”, are added to hydrocarbon recovery compositions in order to improve the water solubility of these surfactants. Co-solvent in alkali-surfactant-polymer or surfactant-polymer hydrocarbon recovery formulations is used both to aid aqueous solubility and to improve interaction with crude oil thereby preventing the formation of highly viscous phases.

However, adding such co-solvent may also lower the solubilization ratio at optimal salinity. Thus, generally, a compromise must be made between maximum solubilization ratio (low IFT) and good aqueous solubility and the other critical factors needed for good mobilization of crude oil under low pressure gradients in oil reservoirs. An additional disadvantage is the associated cost of added co-solvent.

In “Field Test of Cosurfactant-enhanced Alkaline Flooding” by Falls et al., Society of Petroleum Engineers Reservoir Engineering, 1994, the authors describe the use of a C₁₇₋₂₀ or a C₂₀₋₂₄ IOS in a waterflooding composition with an alcohol alkoxylate surfactant to keep the composition as a single phase at ambient temperature.

There is also industry experience with the use of certain alcohol alkoxysulfate surfactants as the main surfactant in cEOR, see for instance U.S. Pat. No. 4,293,428, WO2009100298 and WO2009100300.

However, these materials, used individually, also have disadvantages under relatively severe conditions of salinity or high divalent concentrations. For example in WO2011098493, the use of a surfactant solution comprising an alcohol propoxysulfate is reported. Although, the use of an alcohol propoxysulfate enables the use of the surfactant at higher divalent cation concentrations, the use of an alcohol propoxysulfate alone limits the range of salinities in which it can be used and therefore the ability to formulate a surfactant solution over wider ranges of optimal salinities. WO2011098493 suggests to combine the alcohol propoxysulfate with a further IOS and optionally a co-solvent to improve IOS solubility.

The use of alcohol propoxycarboxylates and alcohol propoxy glycerol sulfonates has been mentioned in for instance US20110028359 and US20110017462, but in again combination with co-solvents.

In particular in off-shore operations, where fresh water is easily not accessible and where the hydrocarbon contains formation has temperature over 70° C., there is a need in the art for a hydrocarbon recovery composition that is suitable for cEOR applications, wherein the hydrocarbon recovery composition is used in combination with high salinity, hard brine formulations, such as seawater or reservoir production water.

### SUMMARY OF THE INVENTION

Surprisingly, it was found that hydrocarbon recovery compositions based on a combination of at least two alkoxylated primary alcohol carboxylates or alkoxylated primary alcohol glycerol sulfonates are suitable for cEOR applications in combination with a wide range of brine salinities and divalent cation concentrations.

Accordingly the present invention provides a hydrocarbon recovery composition, which composition contains:

a) a first anionic surfactant which is selected from the group consisting of a propoxylated primary alcohol carboxylate and propoxylated primary alcohol glycerol sulfonate, having a branched aliphatic group, which group has an average carbon number of in the range of from 8 to 30 and an average number of branches in the range of from 0.5 to 3.5, and having an average in the range of from 1 to 20 mole of propylene oxide groups per mole of primary alcohol; and

b) a second anionic surfactant which is an alkoxylated primary alcohol carboxylate or an alkoxylated primary alcohol glycerol sulfonate selected from the group consisting of (i) an ethoxylated primary alcohol carboxylate, (ii) an ethoxylated-propoxylated primary alcohol carboxylate, (iii) an ethoxylated primary alcohol glycerol sulfonate and (iv) an ethoxylated-propoxylated primary alcohol glycerol sulfonate, the alkoxylated primary alcohol carboxylate or alkoxylated primary glycerol sulfonate having a branched aliphatic group, which group has an average carbon number of in the range of from 8 to 30 and an average number of branches in the range of from 0.5 to 3.5, and having an average in the range of from 1 to 20 mole of alkylene oxide groups per mole of primary alcohol.

The hydrocarbon compositions of the invention are suitable for cEOR applications in combination with a wide range of brine salinities and divalent cation concentrations without the need to add internal olefin sulfonate (IOS) surfactants or to reach optimal salinity at higher brine salinities. The hydrocarbon recovery compositions of the invention can be used over a wide range of brine divalent cation concentrations without the need to add co-solvents to prevent precipitation of the anionic surfactants.

In another aspect, the invention provides an injectable liquid comprising a hydrocarbon recovery composition according to the invention dissolved in an aqueous brine, the brine having a salinity of at least 2 wt % and a hardness of at least 0.01 wt %, wherein the injectable liquid contains in the range of from 0.01 to 2.0 wt % of the first and second anionic surfactant.

In a further aspect, the invention provides a method for treating hydrocarbon containing formations, comprising:

(a) providing a hydrocarbon recovery composition according to the invention to at least a portion of a hydrocarbon containing formation; and

(b) allowing the composition to interact with hydrocarbons in the hydrocarbon containing formation.

The use of alkoxylated primary alcohol carboxylates or alkoxylated primary alcohol glycerol sulfonates is particularly useful for treating hydrocarbon containing formations, which have higher temperatures, in particular above 70° C. Above these temperatures alkoxylated primary alcohol sulfates become prone to thermal degradation, while the alkoxylated primary alcohol carboxylates or alkoxylated primary alcohol glycerol sulfonates of the present invention are much less sensitive to thermal degradation.

In yet a further aspect, the invention provides a hydrocarbon containing composition produced from a hydrocarbon containing formation, which comprises hydrocarbons and a hydrocarbon recovery composition according to the invention.

### BRIEF DESCRIPTION OF THE DRAWINGS

FIG. 1. depicts an embodiment of treating a hydro carbon containing formation.

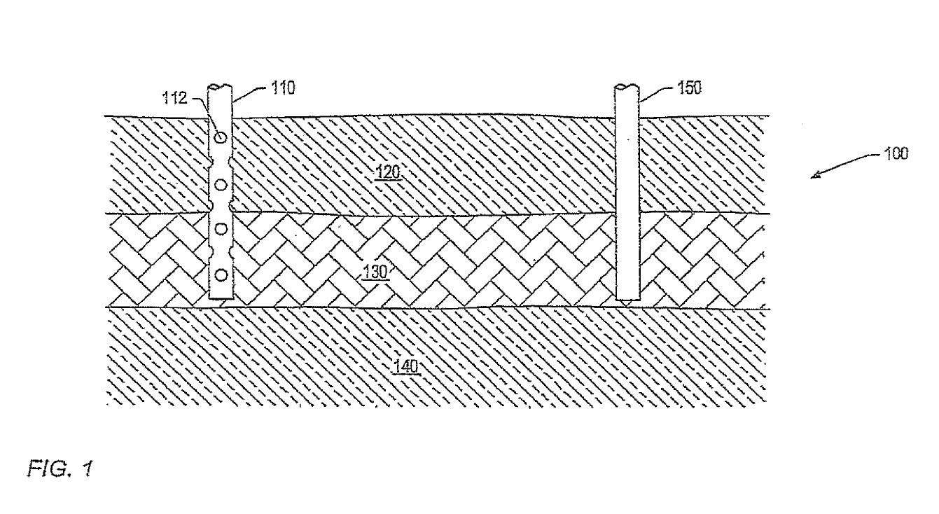

FIG. 2. depicts an embodiment of treating a hydro carbon containing formation.

### DETAILED DESCRIPTION OF THE INVENTION

Hydrocarbons may be produced from hydrocarbon containing formations using cEOR methods. Such methods may include providing a hydrocarbon recovery composition to hydrocarbon containing formations having high salinity and high hardness and/or mixing such hydrocarbon recovery composition with brines having high salinity and high hardness, including for instance sea water or reservoir production water, to form an injectable liquid which is injected into the hydrocarbon containing formations to provide the hydrocarbon recovery composition to hydrocarbon containing formations. The use of sea water or reservoir production water being common when the cEOR method is used in remote or off-shore locations, such as in the North Sea, the Gulf of Mexico, and the Middle East. Reservoir production water as used herein refers to a brine from the hydrocarbon containing formation, which is reinjected into the formation and may be very high in salinity and hardness. As used herein “salinity” refers to an amount of dissolved sodium, potassium, calcium and magnesium salts in an aqueous brine, expressed as wt % based on the total dissolved solids and the total weight of the brine prior to addition of the anionic surfactants. “Water hardness or brine hardness,” as used herein, refers to a concentration of divalent ions (e.g., calcium, magnesium) in an aqueous brine, expressed as wt %, based on the weight of the cation and the total weight of the brine prior to addition of the anionic surfactants.

The present invention provides a hydrocarbon recovery composition and a method of treating a hydrocarbon formation suitable for use in combination the above mentioned high salinity, high hardness conditions.

In the present invention, a hydrocarbon recovery composition is provided that comprises two anionic surfactants. “Surfactant” is the shortened term for “surface-active agent”, which comprises a chemical that stabilizes mixtures of oil and water by reducing the surface tension at the interface between the oil and water molecules. Because water and oil do not dissolve in each other, a surfactant may be added to the mixture to keep it from separating into layers. Any surfactant comprises a hydrophilic part and a hydrophobic part. When the hydrophilic part of a surfactant comprises a negatively charged group like a sulfonate or carboxylate, the surfactant is called anionic. Further, an anionic surfactant comprises a counter cation to compensate for this negative charge.

That is to say, generally, an anionic surfactant has the following formula (I)

[S^{m-}][Mⁿ⁺]ₒ (I)

wherein S is the negatively charged portion of the anionic surfactant, M is a counter cation and the product of n and o (n*o) equals m. Said negatively charged portion “S” thus comprises (i) the hydrophilic part, which comprises a negatively charged group, and (ii) the hydrophobic part of the anionic surfactant.

More in particular, in the present invention, the hydrocarbon recovery composition comprises a first anionic surfactant which is a propoxylated primary alcohol carboxylate or an alkoxylated primary alcohol glycerol sulfonate having a branched aliphatic group, which group has an average carbon number of in the range of from 8 to 30 and an average number of branches in the range of from 0.5 to 3.5, and having an average in the range of from 1 to 20 mole of propylene oxide groups per mole of primary alcohol and

a second anionic surfactant which alkoxylated primary alcohol carboxylate or alkoxylated primary alcohol glycerol sulfonate selected from the group consisting of (i) an ethoxylated primary alcohol carboxylate, (ii) an ethoxylated-propoxylated primary alcohol carboxylate, (iii) an ethoxylated primary alcohol glycerol sulfonate and (iv) an ethoxylated-propoxylated primary alcohol glycerol sulfonate, the alkoxylated primary alcohol carboxylate or alkoxylated primary glycerol sulfonate having a branched aliphatic group, which group has an average carbon number of in the range of from 8 to 30 and an average number of branches in the range of from 0.5 to 3.5, and having an average in the range of from 1 to 20 mole of alkylene oxide groups per mole of primary alcohol.

A primary alcohol herein is an alcohol in which the hydroxyl group is attached to a primary carbon atom.

The combination of the first anionic surfactant and the second anionic surfactant as described herein above provides hydrocarbon compositions that may suitable for cEOR applications in combination with a wide range of brine salinities and divalent cation concentrations without the need to add internal olefin sulfonate (IOS) surfactants to reach optimal salinity at higher brine salinities. Optimal salinity is defined as the concentration of total dissolved solids at which mixing between a hydrocarbon, e.g. crude oil, and a surfactant formulation show the lowest interfacial tension. If the total dissolved solids concentration is varied in a mixture comprising a surfactant formulation and a hydrocarbon, the interfacial tension between the aqueous phase containing the surfactant and the hydrocarbon will be at high levels (>0.1 dynes/cm²) at low salinity, transition through very low levels at optimal salinity (<0.01 dynes/cm²), and climb back to high levels (>0.1 dynes/cm²) at higher salinities. When interfacial tension is at ultra-low levels as achieved at optimal salinity, hydrocarbons can be mobilized in a reservoir.

The anionic surfactants are alkoxylated primary alcohol carboxylates or alkoxylated primary alcohol glycerol sulfonates, which may be described using the following formula (II)

[R—O—[R′—O]ₓ-A¹⁻][Mⁿ⁺]ₒ (II)

[R—O—[R′—O]ₓ—CO₂⁻][Mⁿ⁺]ₒ (IIA)

[R—O—[R′—O]ₓ—C(OH)SO₃⁻][Mⁿ⁺]ₒ (IIb)

wherein R is the branched aliphatic group originating from the primary alcohol, R′—O is an alkylene oxide group originating from the alkylene oxide, x is at least 0.5, A is carboxylate (exemplary formula (IIA)) or glycerol sulfonate group exemplary formula (IIB)), M is a counter cation and the product of n and o (n*o) equals 1.

In above exemplary formula (II) for the alkoxylated primary alcohol carboxylates (herein also referred to as AAC) or alkoxylated primary alcohol glycerol sulfonates (herein also referred to as AAGS) to be used in the present invention, n is an integer. Further, o may be any number which ensures that the anionic surfactant is electrically neutral.

The counter cation in the anionic surfactant to be used in the present invention, denoted as “Mⁿ⁺” in above exemplary formula (II), may be an organic cation, such as a nitrogen containing cation, for example an ammonium cation which may be unsubstituted or substituted. Further, the counter cation may be a metal cation, such as an alkali metal cation or an alkaline earth metal cation. Preferably, such alkali metal cation is lithium cation, sodium cation or potassium cation. Further, preferably, such alkaline earth metal cation is magnesium cation or calcium cation.

In the present invention, the first anionic surfactant in the hydrocarbon recovery composition is selected from the group consisting of a propoxylated primary alcohol carboxylate and a propoxylated primary alcohol glycerol sulfonate.

Preferably, the first anionic surfactant in the hydrocarbon recovery composition is a propoxylated primary alcohol carboxylate (herein also referred to as APC). Reference herein to a propoxylated primary alcohol carboxylate is to an AAC wherein all the alkylene oxide (alkoxy-) groups are propylene oxide groups, i.e. no other alkylene oxide group is present in the AAC. Without wishing to be bound to any particular theory, it is believed that the presence of the APC contributes to the hydrocarbon recovery composition ability to give optimal salinity at relative low brine salinity without precipitating at higher brine salinities when used in concentrations and conditions typical in cEOR applications using AAC comprising surfactants. In particular, this applies as described herein below for the injectable liquid and method of treating hydrocarbon containing formations according to the present invention. The APC of the first anionic surfactant to be used in the present invention has an average of at least 1 mole, preferably in the range of from 2 to 20 moles, more preferably of from 3 to 17 moles, more preferably of from 6 to 14 moles, most preferably of from 7 to 13 moles, of propylene oxide groups per mole of primary alcohol. The average number of moles of propylene oxide groups per mole of primary alcohol in said surfactant is at least 1, preferably at least 2, more preferably at least 3, more preferably at least 4, more preferably at least 5 and most preferably at least 6. Further, the average number of moles of propylene oxide groups per mole of primary alcohol in said surfactant is preferably at most 20, more preferably at most 18, more preferably at most 17, more preferably at most 16, more preferably at most 15 and most preferably at most 14.

The amount of propylene oxide used should not to be too small, in order to minimize the amount of non-alkoxylated alcohol. On the other hand, the amount of propylene oxide used should not to be too high in order to prevent the molecule from losing its ability to function as a surfactant, especially in a case where the carbon number of the branched aliphatic group, denoted as “R” in above exemplary formula (II), is too small relative to the amount of propylene oxide in the molecule.

The aliphatic group of the APC of the first anionic surfactant in the present invention, denoted as “R” in above exemplary formula (II), has an average carbon number in the range of from 8 to 30, preferably of from 10 to 20, more preferably of from 11 to 18, even more preferably of from 12 to 17. The average carbon number of said branched aliphatic group is at least 8, preferably at least 10, more preferably at least 11 and even more preferably at least 12. Further, the average carbon number of said branched aliphatic group is at most 30, preferably at most 20 and more preferably at most 18, still more preferably at most 17. The average carbon number may be determined by NMR analysis.

The aliphatic group of the APC of the first anionic surfactant in the present invention, denoted as “R” in above exemplary formula (II), is a branched aliphatic group and has an average number of branches (i.e. a branching index, BI) in the range of from 0.5 to 3.5, preferably of from 0.7 to 3.5, more preferably of from 0.7 to 2.0, even more preferably of from 0.9 to 1.8, still more preferably of from 1.0 to 1.6. The average number of branches in said branched aliphatic group is at least 0.5, preferably at least 0.6, more preferably at least 0.7, more preferably at least 0.8, more preferably at least 0.9 and most preferably at least 1.0. Further, the average number of branches in said branched aliphatic group is at most 3.5, preferably at most 2.2, more preferably at most 2.1, more preferably at most 2.0, more preferably at most below 2.0, more preferably at most 1.9, more preferably at most 1.8, more preferably at most 1.7, more preferably at most 1.6, more preferably at most 1.5, more preferably at most 1.4, more preferably at most 1.3 and most preferably at most 1.2. The average number of branches may also be determined by NMR analysis.

The majority (i.e. over 50%) of the molecules in the APC of the first anionic surfactant to be used in the present invention has at least one branch in the aliphatic group, denoted as “R” in above exemplary formula (II). That is to say, the weight ratio of linear to branched is smaller than 1:1. Suitably, the molecules are highly branched. For example, at least 70%, suitably at least 80% of the molecules contain at least one branch.

Branches in the branched aliphatic group in the APC of the first anionic surfactant to be used in the present invention, denoted as “R” in above exemplary formula (II), may include, but are not limited to, methyl and/or ethyl branches. Methyl branches may represent in the range of from 20 to 99 percent, more suitably of from 50 to 99 percent, of the total number of branches present in the branched aliphatic group. Ethyl branches, if present, may represent less than 30 percent, more suitably from 0.1 to 2 percent, of the total number of branches present in the branched aliphatic group. Branches other than methyl or ethyl, if present, may represent less than 10 percent, more suitably less than 0.5 percent, of the total number of branches present in the branched aliphatic group.

Further, the branches in the branched aliphatic group in the APC of the first anionic surfactant to be used in the present invention, denoted as “R” in above exemplary formula (II), may have less than 0.5 percent aliphatic quaternary carbon atoms.

A negatively charged carboxylate group is attached to the propylene oxide portion of the APC of the first anionic surfactant to be used in hydrocarbon recovery composition of the present invention. Said negatively charged carboxylate group is a group comprising the —CO₂⁻ moiety. The —CO₂⁻ moiety is attached to the alkylene oxide portion of the anionic surfactant, as shown in exemplary formula (IIA).

Such surfactant is herein referred to as a carboxylate surfactant in view of the presence of an —O—CO₂⁻ moiety.

Where the first anionic surfactant is a propoxylated primary alcohol glycerol sulfonate, the negatively charged group is a glycerol sulfonate, which is attached to the propylene oxide portion of the AAGS of the first anionic surfactant to be used in hydrocarbon recovery composition of the present invention. Said negatively charged glycerol sulfonate group is a group comprising the —C(OH)SO₃⁻ moiety. The —C(OH)SO₃⁻ moiety is attached to the alkylene oxide portion of the anionic surfactant, as shown in exemplary formula (IIB). However, the above mentioned preferred specifications provided herein above for the APC concerning the average number of moles of propylene oxide, average number of carbon atoms in the branched aliphatic group, an average number and type of branches and other properties relating the branched aliphatic group apply mutatis mutandis to the APGS.

The second anionic surfactant in the hydrocarbon recovery composition is an alkoxylated primary alcohol carboxylate or an alkoxylated primary alcohol glycerol sulfonate selected from the group consisting of (i) an ethoxylated primary alcohol carboxylate, (ii) an ethoxylated-propoxylated primary alcohol carboxylate, (iii) an ethoxylated primary alcohol glycerol sulfonate and (iv) an ethoxylated-propoxylated primary alcohol glycerol sulfonate.

Preferably, the second anionic surfactant is an alkoxylated primary alcohol carboxylate (AAC) selected from the group consisting of (i) an ethoxylated primary alcohol carboxylate (herein also referred to as AEC), (ii) an ethoxylated-propoxylated primary alcohol carboxylate (herein also referred to as E-APC). Reference herein to an ethoxylated primary alcohol carboxylate is to an AAC wherein all the alkylene oxide (alkoxy-) groups are ethylene oxide groups, i.e. no other alkylene oxide group is present in the AAC. Reference herein to an ethoxylated-propoxylated primary alcohol carboxylate is to an AAC, wherein the alkylene oxide

(alkoxy-) groups consist of both ethylene oxide and propylene oxide groups as, i.e. no other alkylene oxide group is present in the AAC.

Without wishing to be bound to any particular theory, it is believed that the presence of the ethylene oxide groups in the AEC and E-APC contributes to the hydrocarbon recovery composition ability to withstand the presence of high salinities without precipitating when used in concentrations and conditions typical in cEOR applications using AAC comprising surfactants. In particular, this is true as described herein below for the injectable liquid and method of treating hydrocarbon containing formations according to the present invention.

The AAC of the second anionic surfactant to be used in the present invention has an average of at least 1 mole, preferably in the range of from 2 to 20 moles, more preferably in the range of from 4 to 17 moles, more preferably of from 6 to 14 moles, most preferably of from 7 to 13 moles, of alkylene oxide groups per mole of primary alcohol. The average number of moles of alkylene oxide groups per mole of primary alcohol in said surfactant is at least 1, preferably at least 2, more preferably at least 3, more preferably at least 4, more preferably at least 5 and most preferably at least 6. Further, the average number of moles of alkylene oxide groups per mole of primary alcohol in said surfactant is preferably at most 20, more preferably at most 18, more preferably at most 17, more preferably at most 16, more preferably at most 15 and most preferably at most 14.

The amount of alkylene oxide used should not to be too small in order to minimize the amount of non-alkoxylated alcohol. On the other hand, the amount of alkylene oxide used should not to be too high in order to prevent the molecule from losing its ability to function as a surfactant, especially in a case where the carbon number of the branched aliphatic group, denoted as “R” in above exemplary formula (II), is too small relative to the amount of alkylene oxide in the molecule. In order for the molecule to function successfully as a surfactant in the hydrocarbon containing formation, there must be a proper balance between the length of the oil soluble carbon chain part of the molecule and the water soluble alkylene oxide part of the molecule.

Preferably, the AAC of the second anionic surfactant is an e-APC. Without wishing to be bound by any particular theory, it is believed that the presence of the propylene oxide groups in the AAC of the second anionic surfactant further broadens range of optimal salinities that can be achieved with the hydrocarbon recovery composition of the invention. More preferably an E-APC containing at least two ethylene oxide groups. Where an E-APC is used, the alkylene oxide group, denoted as “[R′—O]ₓ” in above exemplary formula (II), may contain the ethylene oxide and propylene oxide groups in random order. However, it is preferred that the alkylene oxide group, denoted as “[R′—O]ₓ” contains the ethylene oxide and propylene oxide groups grouped in blocks of two or more the ethylene oxide respectively propylene oxide groups. More preferably, the alkylene oxide group, denoted as “[R′—O]ₓ” contains the ethylene oxide and propylene oxide groups grouped in separate two blocks, one containing all the ethylene oxide groups and a second containing all the propylene oxide groups. By grouping the ethylene oxide and propylene oxide groups in blocks, the specific properties of the ethylene oxide groups and the propylene oxide groups may become more pronounced. Still more preferred the alkylene oxide group, denoted as “[R′—O]ₓ” contains a first block containing all the propylene oxide groups, which block is connected at one end with the aliphatic group and at the other end with a block containing all the ethylene oxide groups. Without wishing to be bond to any particularly theory it is believed that by arranging the ethylene oxide groups at the end, this improves the ability of the hydrocarbon recovery composition to resist high salinity conditions.

The aliphatic group of the AAC of the second anionic surfactant in the present invention, denoted as “R” in above exemplary formula (II), has an average carbon number in the range of from 8 to 30, preferably of from 8 to 20, more preferably of from 11 to 17. The average carbon number of said branched aliphatic group is at least 8, preferably at least 10, more preferably at least 11.

Further, the average carbon number of said branched aliphatic group is at most 30, preferably at most 20 and more preferably at most 17. The average carbon number may be determined by NMR analysis.

The aliphatic group of the AAC of the second anionic surfactant in the present invention, denoted as “R” in above exemplary formula (II), is a branched aliphatic group and has an average number of branches (i.e. a branching index, BI) in the range of from 0.5 to 3.5, preferably of from 0.7 to 3.5, preferably of from 0.7 to 2.0, more preferably of from 0.9 to 1.8, most preferably of from 1.0 to 1.6. The average number of branches in said branched aliphatic group is at least 0.5, preferably at least 0.6, more preferably at least 0.7, more preferably at least 0.8, more preferably at least 0.9 and most preferably at least 1.0. Further, the average number of branches in said branched aliphatic group is at most 3.5, preferably at most 2.2, more preferably at most 2.1, more preferably at most 2.0, more preferably at most below 2.0, more preferably at most 1.9, more preferably at most 1.8, more preferably at most 1.7, more preferably at most 1.6, more preferably at most 1.5, more preferably at most 1.4, more preferably at most 1.3 and most preferably at most 1.2. The average number of branches may also be determined by NMR analysis.

The majority (i.e. over 50%) of the molecules in the AAC of the second anionic surfactant to be used in the present invention has at least one branch in the aliphatic group, denoted as “R” in above exemplary formula (II). That is to say, the weight ratio of linear to branched is smaller than 1:1. Suitably, the molecules are highly branched. For example, at least 70%, suitably at least 80% of the molecules contain at least one branch.

Branches in the branched aliphatic group of the AAC of the second anionic surfactant to be used in the present invention, denoted as “R” in above exemplary formula (II), may include, but are not limited to, methyl and/or ethyl branches. Methyl branches may represent in the range of from 20 to 99 percent, more suitably of from 50 to 99 percent, of the total number of branches present in the branched aliphatic group. Ethyl branches, if present, may represent less than 30 percent, more suitably in the range of from 0.1 to 2 percent, of the total number of branches present in the branched aliphatic group. Branches other than methyl or ethyl, if present, may represent less than 10 percent, more suitably less than 0.5 percent, of the total number of branches present in the branched aliphatic group.

Further, the branches in the branched aliphatic group in the AAC of the second anionic surfactant to be used in the present invention, denoted as “R” in above exemplary formula (II), may have less than 0.5 percent aliphatic quaternary carbon atoms.

A negatively charged carboxylate group is attached to the alkylene oxide portion of the AAC of the second anionic surfactant to be used in hydrocarbon recovery composition of the present invention. Said negatively charged carboxylate group is a group comprising the —CO₂⁻ moiety. The —CO₂⁻ moiety is attached to the alkylene oxide portion of the anionic surfactant, as shown in exemplary formula (IIA).

Such surfactant is herein referred to as a carboxylate surfactant in view of the presence of an —O—CO₂⁻ moiety.

Where the second anionic surfactant is an alkoxylated primary alcohol glycerol sulfonate, the negatively charged group is a glycerol sulfonate, which is attached to the alkylene oxide portion of the AAGS of the second anionic surfactant to be used in hydrocarbon recovery composition of the present invention. Said negatively charged glycerol sulfonate group is a group comprising the —C(OH)SO₃⁻ moiety. The —C(OH)SO₃⁻ moiety is attached to the alkylene oxide portion of the anionic surfactant, as shown in exemplary formula (IIB). However, the above mentioned preferred specifications provided herein above for the AAC, including the AEC and E-APC, concerning the average number of moles of propylene oxide, average number of carbon atoms in the branched aliphatic group, an average number and type of branches and other properties relating the branched aliphatic group and in addition the grouping of the alkylene oxides, i.e. ethylene oxide and propylene oxide, in the alkylene group, denoted as “[R′—O]ₓ” apply mutatis mutandis.

Preferably, both the first anionic surfactant and the second anionic surfactant are carboxylates, i.e. the first anionic surfactant is a propoxylated primary alcohol carboxylate and the second anionic surfactant is an alkoxylated primary alcohol carboxylate selected from the group consisting of (i) an ethoxylated primary alcohol carboxylate and (ii) an ethoxylated-propoxylated primary alcohol carboxylate. Preferably, the hydrocarbon recovery composition is a hydrocarbon recovery composition, which composition contains:

a) a first anionic surfactant which is a propoxylated primary alcohol carboxylate having a branched aliphatic group, which group has an average carbon number of in the range of from 8 to 30 and an average number of branches in the range of from 0.5 to 3.5, and having an average in the range of from 1 to 20 mole of propylene oxide groups per mole of primary alcohol; and

b) a second anionic surfactant which is an alkoxylated primary alcohol carboxylate selected from the group consisting of (i) an ethoxylated primary alcohol carboxylate, and (ii) an ethoxylated-propoxylated primary alcohol carboxylate, the alkoxylated primary alcohol carboxylate having a branched aliphatic group, which group has an average carbon number of in the range of from 8 to 30 and an average number of branches of from 0.5 to 3.5, and having an average of from 1 to 20 mole of alkylene oxide groups per mole of primary alcohol.

Preferably, the hydrocarbon recovery composition contains the first and second anionic surfactants in a weight ratio of the first to the second anionic surfactant is in the range of from 90:10 to 30:70, more preferably of from 85:15 to 35:65.

The branched primary alcohol, from which the anionic surfactants from the hydrocarbon recovery composition of the present invention, originates, may be prepared by hydroformylation of a branched alpha-olefin. Preparations of branched olefins are described in U.S. Pat. No. 5,510,306, U.S. Pat. No. 5,648,584 and U.S. Pat. No. 5,648,585, the disclosures of all of which are incorporated herein by reference. Preparations of branched long chain aliphatic alcohols are described in U.S. Pat. No. 5,849,960, U.S. Pat. No. 6,150,222, U.S. Pat. No. 6,222,077, the disclosures of all of which are incorporated herein by reference.

The primary alcohol used in preparing the anionic surfactants of the hydrocarbon recovery composition of the present invention, may be alkoxylated by reacting with alkylene oxide in the presence of an appropriate alkoxylation catalyst. The alkoxylation catalyst may be potassium hydroxide or sodium hydroxide which is commonly used commercially for alkoxylating alcohols. The primary alcohols may be alkoxylated using a double metal cyanide catalyst as described in U.S. Pat. No. 6,977,236, the disclosure of which is incorporated herein by reference. The primary alcohols may also be alkoxylated using a lanthanum-based or a rare earth metal-based alkoxylation catalyst as described in U.S. Pat. No. 5,059,719 and U.S. Pat. No. 5,057,627, the disclosures of which are incorporated herein by reference.

Primary alcohol alkoxylates may be prepared by adding to the primary alcohol or mixture of primary alcohols a calculated amount, for example from 0.1 percent by weight to 0.6 percent by weight, of a strong base, typically an alkali metal or alkaline earth metal hydroxide such as sodium hydroxide or potassium hydroxide, which serves as a catalyst for alkoxylation. An amount of alkylene oxide calculated to provide the desired number of moles of alkylene oxide groups per mole of primary alcohol is then introduced and the resulting mixture is allowed to react until the alkylene oxide is consumed. Suitable reaction temperatures range from 120 to 220° C.

Primary alcohol alkoxylates may be prepared by using a multi-metal cyanide catalyst as the alkoxylation catalyst. The catalyst may be contacted with the primary alcohol and then both may be contacted with the alkylene oxide reactant which may be introduced in gaseous form. The reaction temperature may range from 90° C. to 250° C. and super atmospheric pressures may be used if it is desired to maintain the primary alcohol substantially in the liquid state.

Narrow molecular weight range primary alcohol alkoxylates may be produced by utilizing a soluble basic compound of elements in the lanthanum series elements or the rare earth elements as the alkoxylation catalyst. Lanthanum phosphate is particularly useful. The alkoxylation is carried out employing conventional reaction conditions such as those described above.

It should be understood that the alkoxylation procedure serves to introduce a desired average number of alkylene oxide units per mole of primary alcohol alkoxylate. For example, treatment of a primary alcohol mixture with 1.5 moles of alkylene oxide per mole of primary alcohol serves to effect the alkoxylation of each alcohol molecule with an average of 1.5 alkylene oxide groups per mole of primary alcohol, although a substantial proportion of primary alcohol will have become combined with more than 1.5 alkylene oxide groups and an approximately equal proportion will have become combined with less than 1.5. In a typical alkoxylation product mixture, there is also a minor proportion of unreacted primary alcohol. Ethoxylated-propoxylated primary alcohols may be prepared as described above using a mixture of ethylene oxide and propylene oxide to give an ethoxylated-propoxylated primary alcohol, wherein the ethylene oxide and propylene oxide groups are randomly distributed in the alkylene oxide group. Ethoxylated-propoxylated primary alcohols containing separate blocks of ethylene oxide and propylene oxide, as described herein above, can be prepared by sequential alkoxylation steps, wherein the sequentially either ethylene oxide or propylene oxide is provided as alkylene oxide reactant.

The alkoxylated branched primary alcohol of this invention may be carboxylated by any of a number of well-known methods. It may be reacted with a halogenated carboxylic acid to make a carboxylic acid. Alternatively, the alcoholic end group—CH₂OH—may be oxidized to yield a carboxylic acid. In either case, the resulting carboxylic acid may then be neutralized with an alkali metal base to form a carboxylate surfactant.

In a specific example, an alkoxylated branched primary alcohol may be reacted with potassium t-butoxide and initially heated at, for example, 60° C. under reduced pressure for, for example, 10 hours. It would be allowed to cool and then sodium chloroacetate would be added to the mixture. The reaction temperature would be increased to, for example, 90° C. under reduced pressure for, for example, 20-21 hours. It would be cooled to room temperature and water and hydrochloric acid added. This would be heated to, for example, 90° C. for, for example, 2 hours. The organic layer may be extracted by adding ethyl acetate and washing it with water.

In the preparation of the alkoxylated primary alcohols glycerol sulfonates derived from the alkoxylated primary alcohols of the present invention, the alkoxylates are reacted with epichlorohydrin, preferably in the presence of a catalyst such as tin tetrachloride at from about 110 to about 120° C. for from about 3 to about 5 hours at a pressure of about 14.7 to about 15.7 psia (about 100 to about 110 kPa) in toluene. Next, the reaction product is reacted with a base such as sodium hydroxide or potassium hydroxide at from about 85 to about 95° C. for from about 2 to about 4 hours at a pressure of about 14.7 to about 15.7 psia (about 100 to about 110 kPa). The reaction mixture is cooled and separated in two layers. The organic layer is separated and the product isolated. It is then reacted with sodium bisulfite and sodium sulfite at from about 140 to about 160° C. for from about 3 to about 5 hours at a pressure of about 60 to about 80 psia (about 400 to about 550 kPa). The reaction is cooled and the product glycerol sulfonate is recovered as about a 25 wt % active matter solution in water. The reactor is preferably a 500 ml zipperclave reactor.

The hydrocarbon recovery composition of the present invention may preferably comprise 8 wt % or more, for example of from 8 to 90 wt % of the above-discussed first and second anionic surfactants, based on the weight of the hydrocarbon recovery composition. Said percentages do not apply to the anionic surfactant as present in the fluid that may be injected into the hydrocarbon containing formation in the present method. In such fluid, the surfactant concentration is relatively low, as further discussed below.

In the present invention, surprisingly, no co-solvent is required and preferably no co-solvent is provided as part of the hydrocarbon recovery composition. It is desirable that no or substantially less co-solvent may be used in hydrocarbon recovery formulations and that at the same time an effective EOR performance of such formulations is still maintained. Using no or substantially less co-solvent is very important because co-solvent is a major chemical component of a surfactant EOR operation in terms of cost and complexity. Example of co-solvents that are mentioned in the prior art are C1-C4 alkyl alcohols are methanol, ethanol, 1-propanol, 2-propanol (isopropyl alcohol), 1-butanol, 2-butanol (sec-butyl alcohol), 2-methyl-1-propanol (iso-butyl alcohol) and 2-methyl-2-propanol (tert-butyl alcohol), 1-pentanol, 2-pentanol and 3-pentanol, and branched C5 alkyl alcohols, such as 2-methyl-2-butanol (tert-amyl alcohol), 1-hexanol, 2-hexanol and 3-hexanol, branched C6 alkyl alcohols, methyl ethyl ketone, acetone, lower alkyl cellosolves, lower alkyl carbitols.

Preferably, in the present invention, the hydrocarbon recovery composition contains no co-solvent.

In the present invention, surprisingly, no IOS surfactant presence is required as part of the hydrocarbon recovery composition at high salinities. As IOS surfactants may undesirably precipitate at higher divalent cation concentrations, it is preferred that the hydrocarbon recovery composition contains no IOS surfactants.

In a further aspect, the invention relates to an injectable liquid. The hydrocarbon recovery composition of the present invention may be provided to a hydrocarbon containing formation by diluting it with water and/or brine, thereby forming a fluid that can be injected into the hydrocarbon containing formation, that is to say the injectable liquid.

The injectable liquid may comprise of from 0.01 to 4 wt % of the first and second anionic surfactant, based on the weight of the injectable liquid, in addition to the water and/or brine that is contained in the injectable liquid. The amount of the first and second anionic surfactant in the injectable liquid may be in the range of from 0.01 to 3.0 wt %, preferably of from 0.01 to 2.0 wt %, preferably of from 0.1 to 1.5 wt %, more preferably of from 0.1 to 1.0 wt %, most preferably of from 0.2 to 0.5 wt %, based on the weight of the injectable liquid.

In the present invitation, the hydrocarbon recovery composition of the invention is dissolved in a brine having a salinity of at least 2 wt %, preferably at least 3 wt %, more preferably at least 5 wt %, even more preferably at least 8 wt %, still more at least 10 wt %, based on the total dissolved solids and the total weight of the brine prior to addition of the anionic surfactants. In particular, the hydrocarbon recovery composition of the invention is dissolved in a brine having a salinity of at most 30 wt %, preferably at most 20 wt %, more preferably at most 15 wt % based on the total dissolved solids and the total weight of the brine prior to addition of the anionic surfactants. The advantages of the present invention become particularly beneficial at high brine salinities.

In the present invention, the hydrocarbon recovery composition of the invention is dissolved in a brine having a hardness of at least 0.01 wt %, preferably at least 0.05 wt %, more preferably at least 0.1 wt %, even more preferably at least 0.5 wt %, still more preferably at least 1 wt %, based on the weight of the divalent cations and the total weight of the brine prior to addition of the anionic surfactants. Preferably, the hydrocarbon recovery composition of the invention is dissolved in a brine having a salinity of no more than 2 wt, based on the weight of the divalent cations and the total weight of the brine prior to addition of the anionic surfactants. The advantages of the present invention become particularly beneficial at high brine hardness.

The water or brine that is used as part of the injectable liquid may be any suitable water or brine, but preferably contains at least sea water or reservoir production water. The latter may originate from the formation from which hydrocarbons are to be recovered. Sea water is particularly suitable in off-shore locations.

In the present invention, surprisingly, no co-solvent is required and preferably no co-solvent is provided as part of the injectable liquid. It is desirable that no or substantially less co-solvent may be used in injectable liquid and that at the same time an effective EOR performance of such formulations is still maintained. Using no or substantially less co-solvent is very important because co-solvent is a major chemical component of a surfactant EOR operation in terms of cost and complexity. Example of co-solvents were mentioned herein above. Preferably, in the present invention, the injectable liquid contains no co-solvent.

In the present invention, surprisingly, no IOS surfactant presence is required as part of the injectable liquid at high salinities. As IOS surfactants may undesirably precipitate at higher divalent cation concentrations, it is preferred that the injectable liquid contains no IOS surfactants. Moreover, it is preferred that the injectable liquid does not show any phase separation. In particular, the injectable liquid preferably contains no more than one liquid phase. Preferably, the injectable liquid contains no solid phases. Preferably, the injectable liquid is a single phase liquid.

In a further aspect, the invention relates to a method of treating hydrocarbon containing formations, preferably high salinity, high hardness hydrocarbon containing formations.

The hydrocarbon recovery composition is thermally stable and may be used over a wide range of temperature. In some embodiments, a hydrocarbon recovery composition may be added to a portion of a hydrocarbon containing formation that has an average temperature in teh range of from 0 to 150° C., preferably of from 70 to 150° C., even more preferably of from 75 to 150° C., because of the high thermal stability of the glycerol derivative.

The method of hydrocarbon containing formations, comprises

(a) providing a hydrocarbon recovery composition according to the invention to at least a portion of a hydrocarbon containing formation; and

(b) allowing the composition to interact with hydrocarbons in the hydrocarbon containing formation.

Concurrently or subsequently, the method may include retrieving hydrocarbons from the hydrocarbon containing formation.

Preferably, hydrocarbon recovery composition is provided to the hydrocarbon containing formation as part of an injectable liquid according to the invention. It is preferred that the injectable liquid contains reservoir production water.

Hydrocarbons may be produced from hydrocarbon formations through wells penetrating a hydrocarbon containing formation. “Hydrocarbons” are generally defined as molecules formed primarily of carbon and hydrogen atoms such as oil and natural gas. Hydrocarbons may also include other elements, such as, but not limited to, halogens, metallic elements, nitrogen, oxygen and/or sulfur. Hydrocarbons derived from a hydrocarbon formation may include, but are not limited to, kerogen, bitumen, pyrobitumen, asphaltenes, oils or combinations thereof. Hydrocarbons may be located within or adjacent to mineral matrices within the earth. Matrices may include, but are not limited to, sedimentary rock, sands, silicilytes, carbonates, diatomites and other porous media.

A “formation” includes one or more hydrocarbon containing layers, one or more non-hydrocarbon layers, an overburden and/or an underburden. An “overburden” and/or an “underburden” includes one or more different types of impermeable materials. For example, overburden/underburden may include rock, shale, mudstone, or wet/tight carbonate (i.e., an impermeable carbonate without hydrocarbons). For example, an underburden may contain shale or mudstone. In some cases, the overburden/underburden may be somewhat permeable. For example, an underburden may be composed of a permeable mineral such as sandstone or limestone. At least a portion of a hydrocarbon containing formation may exist at less than or more than 1000 feet (305 meters) below the earth's surface.

Properties of a hydrocarbon containing formation may affect how hydrocarbons flow through an underburden/overburden to one or more production wells. Properties include, but are not limited to, porosity, permeability, pore size distribution, surface area, salinity or temperature of formation. Overburden/underburden properties in combination with hydrocarbon properties, such as, capillary pressure (static) characteristics and relative permeability (flow) characteristics may affect mobilization of hydrocarbons through the hydrocarbon containing formation.

Permeability of a hydrocarbon containing formation may vary depending on the formation composition. A relatively permeable formation may include heavy hydrocarbons entrained in, for example, sand or carbonate. “Relatively permeable,” as used herein, refers to formations or portions thereof, that have an average permeability of 10 millidarcy or more. “Relatively low permeability” as used herein, refers to formations or portions thereof that have an average permeability of less than 10 millidarcy. One darcy is equal to 0.99 square micrometers. An impermeable portion of a formation generally has a permeability of less than 0.1 millidarcy.

Fluids (e.g., gas, water, hydrocarbons or combinations thereof) of different densities may exist in a hydrocarbon containing formation. A mixture of fluids in the hydrocarbon containing formation may form layers between an underburden and an overburden according to fluid density. Gas may form a top layer, hydrocarbons may form a middle layer and water may form a bottom layer in the hydrocarbon containing formation. The fluids may be present in the hydrocarbon containing formation in various amounts. Interactions between the fluids in the formation may create interfaces or boundaries between the fluids. Interfaces or boundaries between the fluids and the formation may be created through interactions between the fluids and the formation. Typically, gases do not form boundaries with other fluids in a hydrocarbon containing formation. A first boundary may form between a water layer and underburden. A second boundary may form between a water layer and a hydrocarbon layer. A third boundary may form between hydrocarbons of different densities in a hydrocarbon containing formation. Multiple fluids with multiple boundaries may be present in a hydrocarbon containing formation. It should be understood that many combinations of boundaries between fluids and between fluids and the overburden/underburden may be present in a hydrocarbon containing formation.

Production of fluids may perturb the interaction between fluids and between fluids and the overburden/underburden. As fluids are removed from the hydrocarbon containing formation, the different fluid layers may mix and form mixed fluid layers. The mixed fluids may have different interactions at the fluid boundaries. Depending on the interactions at the boundaries of the mixed fluids, production of hydrocarbons may become difficult. Quantification of the interactions (e.g., energy level) at the interface of the fluids and/or fluids and overburden/underburden may be useful to predict mobilization of hydrocarbons through the hydrocarbon containing formation.

Quantification of energy required for interactions (e.g., mixing) between fluids within a formation at an interface may be difficult to measure. Quantification of energy levels at an interface between fluids may be determined by generally known techniques (e.g., spinning drop tensiometer). Interaction energy requirements at an interface may be referred to as interfacial tension. “Interfacial tension” as used herein, refers to a surface free energy that exists between two or more fluids that exhibit a boundary. A high interfacial tension value (e.g., greater than 10 dynes/cm) may indicate the inability of one fluid to mix with a second fluid to form a fluid emulsion. As used herein, an “emulsion” refers to a dispersion of one immiscible fluid into a second fluid by addition of a composition that reduces the interfacial tension between the fluids to achieve stability. The inability of the fluids to mix may be due to high surface interaction energy between the two fluids. Low interfacial tension values (e.g., less than 1 dyne/cm) may indicate less surface interaction between the two immiscible fluids. Less surface interaction energy between two immiscible fluids may result in the mixing of the two fluids to form an emulsion. Fluids with low interfacial tension values may be mobilized to a well bore due to reduced capillary forces and subsequently produced from a hydrocarbon containing formation.

Fluids in a hydrocarbon containing formation may wet (e.g., adhere to an overburden/underburden or spread onto an overburden/underburden in a hydrocarbon containing formation). As used herein, “wettability” refers to the preference of a fluid to spread on or adhere to a solid surface in a formation in the presence of other fluids. Methods to determine wettability of a hydrocarbon formation are described by Craig, Jr. in “The Reservoir Engineering Aspects of Waterflooding”, 1971 Monograph Volume 3, Society of Petroleum Engineers, which is herein incorporated by reference.

Hydrocarbons may adhere to sandstone in the presence of gas or water. An overburden/underburden that is substantially coated by hydrocarbons may be referred to as “oil wet”. An overburden/underburden may be oil wet due to the presence of polar and/or heavy hydrocarbons (e.g., asphaltenes) in the hydrocarbon containing formation. Formation composition (e.g., silica, carbonate or clay) may determine the amount of adsorption of hydrocarbons on the surface of an overburden/underburden. A porous and/or permeable formation may allow hydrocarbons to more easily wet the overburden/underburden. A substantially oil wet overburden/underburden may inhibit hydrocarbon production from the hydrocarbon containing formation. An oil wet portion of a hydrocarbon containing formation may be located at less than or more than 1000 feet (305 metres) below the earth's surface.

A hydrocarbon containing formation may include water. Water may interact with the surface of the underburden. As used herein, “water wet” refers to the formation of a coat of water on the surface of the overburden/underburden. A water wet overburden/underburden may enhance hydrocarbon production from the formation by preventing hydrocarbons from wetting the overburden/underburden. A water wet portion of a hydrocarbon containing formation may include minor amounts of polar and/or heavy hydrocarbons.

Water in a hydrocarbon containing formation may contain minerals (e.g., minerals containing barium, calcium, or magnesium) and mineral salts (e.g., sodium chloride, potassium chloride, magnesium chloride). Water salinity and/or water hardness of water in a formation may affect recovery of hydrocarbons in a hydrocarbon containing formation. As used herein “salinity” refers to an amount of dissolved solids in water. “Water hardness”, as used herein, refers to a concentration of divalent ions (e.g., calcium, magnesium) in the water. Water salinity and hardness may be determined by generally known methods (e.g., conductivity, titration). As used herein, “a high salinity hydrocarbon containing formation” refers to a hydrocarbon containing formation containing water that has greater than 20,000 ppm total dissolved solids. A hydrocarbon containing formation may be selected for treatment based on factors such as, but not limited to, thickness of hydrocarbon containing layers within the formation, assessed liquid production content, location of the formation, salinity content of the formation, temperature of the formation, and depth of hydrocarbon containing layers. Initially, natural formation pressure and temperature may be sufficient to cause hydrocarbons to flow into well bores and out to the surface. As hydrocarbons are produced from a hydrocarbon containing formation, pressures and/or temperatures within the formation may decline. Various forms of artificial lift (e.g., pumps, gas injection) and/or heating may be employed to continue to produce hydrocarbons from the hydrocarbon containing formation. Production of desired hydrocarbons from the hydrocarbon containing formation may become uneconomical as hydrocarbons are depleted from the formation and/or as the difficulty of extraction increases.

Mobilization of residual hydrocarbons retained in a hydrocarbon containing formation may be difficult due to viscosity of the hydrocarbons and capillary effects of fluids in pores of the hydrocarbon containing formation. As used herein “capillary forces” refers to attractive forces between fluids and at least a portion of the hydrocarbon containing formation. Capillary forces may be overcome by increasing the pressures within a hydrocarbon containing formation. Capillary forces may also be overcome by reducing the interfacial tension between fluids in a hydrocarbon containing formation. The ability to reduce the capillary forces in a hydrocarbon containing formation may depend on a number of factors, including, but not limited to, the temperature of the hydrocarbon containing formation, the salinity of water in the hydrocarbon containing formation, and the composition of the hydrocarbons in the hydrocarbon containing formation.

As production rates decrease, additional methods may be employed to make a hydrocarbon containing formation more economically viable. Methods may include adding sources of water (e.g., brine, steam), gases, polymers, monomers or any combinations thereof to the hydrocarbon formation to increase mobilization of hydrocarbons.

A hydrocarbon containing formation may be treated with a flood of water. A waterflood may include injecting water into a portion of a hydrocarbon containing formation through injections wells. Flooding of at least a portion of the formation may water wet a portion of the hydrocarbon containing formation. The water wet portion of the hydrocarbon containing formation may be pressurized by known methods and a water/hydrocarbon mixture may be collected using one or more production wells. The water layer, however, may not mix with the hydrocarbon layer efficiently. Poor mixing efficiency may be due to a high interfacial tension between the water and hydrocarbons.

Production from a hydrocarbon containing formation may be enhanced by treating the hydrocarbon containing formation with a polymer that may mobilize hydrocarbons to one or more production wells. The polymer may reduce the mobility of the water phase in pores of the hydrocarbon containing formation. The reduction of water mobility may allow the hydrocarbons to be more easily mobilized through the hydrocarbon containing formation. Polymers include, but are not limited to, polyacrylamides, partially hydrolyzed polyacrylamide, polyacrylates, ethylenic copolymers, biopolymers, carboxymethylcellulose, polyvinyl alcohol, polystyrene sulfonates, polyvinylpyrrolidone, AMPS (2-acrylamide-2-methyl propane sulfonate) or combinations thereof. Examples of ethylenic copolymers include copolymers of acrylic acid and acrylamide, acrylic acid and lauryl acrylate, lauryl acrylate and acrylamide. Examples of biopolymers include xanthan gum and guar gum. Polymers may be crosslinked in situ in a hydrocarbon containing formation. Polymers may also be generated in situ in a hydrocarbon containing formation. Polymers and polymer preparations for use in oil recovery are described in U.S. Pat. No. 6,427,268, U.S. Pat. No. 6,439,308, U.S. Pat. No. 5,654,261, U.S. Pat. No. 5,284,206, U.S. Pat. No. 5,199,490 and U.S. Pat. No. 5,103,909, the disclosures of all of which are incorporated herein by reference.

The hydrocarbon recovery composition of the present invention can advantageously be used under reservoir conditions at various elevated salinities and divalent cation concentrations. For example, in the AAC, the connecting alkylene oxide group links the alcohol hydrophobe to the negatively charged group A and is used to change the HLB of the molecule and match it to reservoir conditions in terms of salinity and crude oil. “HLB” stands for hydrophile-lipophile balance. The hydrocarbon recovery composition may interact with hydrocarbons in at least a portion of the hydrocarbon containing formation. Interaction with the hydrocarbons may reduce an interfacial tension of the hydrocarbons with one or more fluids in the hydrocarbon containing formation. A hydrocarbon recovery composition may reduce the interfacial tension between the hydrocarbons and an overburden/underburden of a hydrocarbon containing formation. Reduction of the interfacial tension may allow at least a portion of the hydrocarbons to mobilize through the hydrocarbon containing formation.

The ability of a hydrocarbon recovery composition to reduce the interfacial tension of a mixture of hydrocarbons and fluids may be evaluated using known techniques. An interfacial tension value for a mixture of hydrocarbons and water may be determined using a spinning drop tensiometer. An amount of the hydrocarbon recovery composition may be added to the hydrocarbon/water mixture and an interfacial tension value for the resulting fluid may be determined. A low interfacial tension value (e.g., less than 1 dyne/cm) may indicate that the composition reduced at least a portion of the surface energy between the hydrocarbons and water. Reduction of surface energy may indicate that at least a portion of the hydrocarbon/water mixture may mobilize through at least a portion of a hydrocarbon containing formation.

A hydrocarbon recovery composition may be added to a hydrocarbon/water mixture and the interfacial tension value may be determined. An ultralow interfacial tension value (e.g., less than 0.01 dyne/cm) may indicate that the hydrocarbon recovery composition lowered at least a portion of the surface tension between the hydrocarbons and water such that at least a portion of the hydrocarbons may mobilize through at least a portion of the hydrocarbon containing formation. At least a portion of the hydrocarbons may mobilize more easily through at least a portion of the hydrocarbon containing formation at an ultra low interfacial tension than hydrocarbons that have been treated with a composition that results in an interfacial tension value greater than 0.01 dynes/cm for the fluids in the formation. Addition of a hydrocarbon recovery composition to fluids in a hydrocarbon containing formation that results in an ultra-low interfacial tension value may increase the efficiency at which hydrocarbons may be recovered. A hydrocarbon recovery composition concentration in the hydrocarbon containing formation may be minimized to minimize cost of use during production.

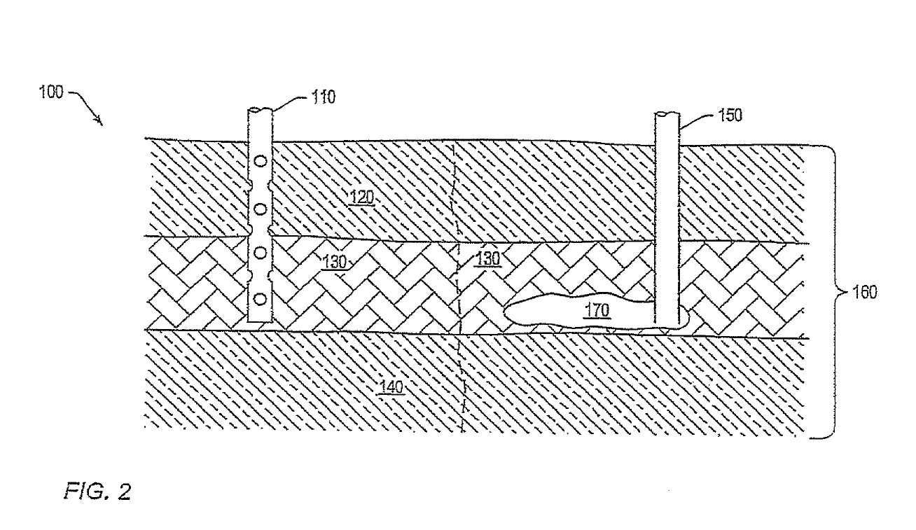

The hydrocarbon recovery composition of the present invention may be provided (e.g., injected) into hydrocarbon containing formation 100 through injection well 110 as depicted in FIG. 2. Hydrocarbon formation 100 may include overburden 120, hydrocarbon layer 130, and underburden 140. Injection well 110 may include openings 112 that allow fluids to flow through hydrocarbon containing formation 100 at various depth levels. Hydrocarbon layer 130 may be less than 1000 feet (305 metres) below earth's surface. Underburden 140 of hydrocarbon containing formation 100 may be oil wet. Low salinity water may be present in hydrocarbon containing formation 100.

The hydrocarbon recovery composition of the present invention may be provided to the formation in an amount based on hydrocarbons present in a hydrocarbon containing formation. The amount of hydrocarbon recovery composition, however, may be too small to be accurately delivered to the hydrocarbon containing formation using known delivery techniques (e.g., pumps). To facilitate delivery of small amounts of the hydrocarbon recovery composition to the hydrocarbon containing formation, the hydrocarbon recovery composition may be combined with water and/or brine to produce an injectable liquid.

The hydrocarbon recovery composition of the present invention may interact with at least a portion of the hydrocarbons in hydrocarbon layer 130. The interaction of the hydrocarbon recovery composition with hydrocarbon layer 130 may reduce at least a portion of the interfacial tension between different hydrocarbons. The hydrocarbon recovery composition may also reduce at least a portion of the interfacial tension between one or more fluids (e.g., water, hydrocarbons) in the formation and the underburden 140, one or more fluids in the formation and the overburden 120 or combinations thereof.

The hydrocarbon recovery composition of the present invention may interact with at least a portion of hydrocarbons and at least a portion of one or more other fluids in the formation to reduce at least a portion of the interfacial tension between the hydrocarbons and one or more fluids. Reduction of the interfacial tension may allow at least a portion of the hydrocarbons to form an emulsion with at least a portion of one or more fluids in the formation. An interfacial tension value between the hydrocarbons and one or more fluids may be altered by the hydrocarbon recovery composition to a value of less than 0.1 dyne/cm. An interfacial tension value between the hydrocarbons and other fluids in a formation may be reduced by the hydrocarbon recovery composition to be less than 0.05 dyne/cm. An interfacial tension value between hydrocarbons and other fluids in a formation may be lowered by the hydrocarbon recovery composition to less than 0.001 dyne/cm.

At least a portion of the hydrocarbon recovery composition/hydrocarbon/fluids mixture may be mobilized to production well 150. Products obtained from the production well 150 may include, but are not limited to, components of the hydrocarbon recovery composition, methane, carbon monoxide, water, hydrocarbons, ammonia, asphaltenes, or combinations thereof. Hydrocarbon production from hydrocarbon containing formation 100 may be increased by greater than 50% after the hydrocarbon recovery composition has been added to a hydrocarbon containing formation.

Hydrocarbon containing formation 100 may be pretreated with a hydrocarbon removal fluid. A hydrocarbon removal fluid may be composed of water, steam, brine, gas, liquid polymers, foam polymers, monomers or mixtures thereof. A hydrocarbon removal fluid may be used to treat a formation before a hydrocarbon recovery composition is provided to the formation. Hydrocarbon containing formation 100 may be less than 1000 feet (305 metres) below the earth's surface. A hydrocarbon removal fluid may be heated before injection into a hydrocarbon containing formation 100. A hydrocarbon removal fluid may reduce a viscosity of at least a portion of the hydrocarbons within the formation. Reduction of the viscosity of at least a portion of the hydrocarbons in the formation may enhance mobilization of at least a portion of the hydrocarbons to production well 150. After at least a portion of the hydrocarbons in hydrocarbon containing formation 100 have been mobilized, repeated injection of the same or different hydrocarbon removal fluids may become less effective in mobilizing hydrocarbons through the hydrocarbon containing formation. Low efficiency of mobilization may be due to hydrocarbon removal fluids creating more permeable zones in hydrocarbon containing formation 100. Hydrocarbon removal fluids may pass through the permeable zones in the hydrocarbon containing formation 100 and not interact with and mobilize the remaining hydrocarbons. Consequently, displacement of heavier hydrocarbons adsorbed to underburden 140 may be reduced over time. Eventually, the formation may be considered low producing or economically undesirable to produce hydrocarbons.

Injection of the hydrocarbon recovery composition of the present invention after treating the hydrocarbon containing formation with a hydrocarbon removal fluid may enhance mobilization of heavier hydrocarbons absorbed to underburden 140. The hydrocarbon recovery composition may interact with the hydrocarbons to reduce an interfacial tension between the hydrocarbons and underburden 140. Reduction of the interfacial tension may be such that hydrocarbons are mobilized to and produced from production well 150. Produced hydrocarbons from production well 150 may include at least a portion of the components of the hydrocarbon recovery composition, the hydrocarbon removal fluid injected into the well for pretreatment, methane, carbon dioxide, ammonia, or combinations thereof. Adding the hydrocarbon recovery composition to at least a portion of a low producing hydrocarbon containing formation may extend the production life of the hydrocarbon containing formation. Hydrocarbon production from hydrocarbon containing formation 100 may be increased by greater than 50% after the hydrocarbon recovery composition has been added to hydrocarbon containing formation. Increased hydrocarbon production may increase the economic viability of the hydrocarbon containing formation.

Interaction of the hydrocarbon recovery composition with at least a portion of hydrocarbons in the formation may reduce at least a portion of an interfacial tension between the hydrocarbons and underburden 140. Reduction of at least a portion of the interfacial tension may mobilize at least a portion of hydrocarbons through hydrocarbon containing formation 100. Mobilization of at least a portion of hydrocarbons, however, may not be at an economically viable rate.

Polymers may be injected into hydrocarbon formation 100 through injection well 110, after treatment of the formation with a hydrocarbon recovery composition, to increase mobilization of at least a portion of the hydrocarbons through the formation. Suitable polymers include, but are not limited to, Flopaam® manufactured by SNF, CIBA® ALCOFLOOD®, manufactured by Ciba Specialty Additives (Tarrytown, N.Y.), Tramfloc® manufactured by Tramfloc Inc. (Temple, Ariz.), and HE® polymers manufactured by Chevron Phillips Chemical Co. (The Woodlands, Tex.). Interaction between the hydrocarbons, the hydrocarbon recovery composition and the polymer may increase mobilization of at least a portion of the hydrocarbons remaining in the formation to production well 150.

The hydrocarbon recovery composition may also be injected into hydrocarbon containing formation 100 through injection well 110 as depicted in FIG. 3. Interaction of the hydrocarbon recovery composition with hydrocarbons in the formation may reduce at least a portion of an interfacial tension between the hydrocarbons and underburden 140. Reduction of at least a portion of the interfacial tension may mobilize at least a portion of hydrocarbons to a selected section 160 in hydrocarbon containing formation 100 to form hydrocarbon pool 170. At least a portion of the hydrocarbons may be produced from hydrocarbon pool 170 in the selected section of hydrocarbon containing formation 100.

Mobilization of at least a portion of hydrocarbons to selected section 160 may not be at an economically viable rate. Polymers may be injected into hydrocarbon formation 100 to increase mobilization of at least a portion of the hydrocarbons through the formation. Interaction between at least a portion of the hydrocarbons, the hydrocarbon recovery composition and the polymers may increase mobilization of at least a portion of the hydrocarbons to production well 150.

A hydrocarbon recovery composition may include an inorganic salt (e.g. sodium carbonate (Na₂CO₃), sodium chloride (NaCl), or calcium chloride (CaCl₂)). The addition of the inorganic salt may help the hydrocarbon recovery composition disperse throughout a hydrocarbon/water mixture. The enhanced dispersion of the hydrocarbon recovery composition may decrease the interactions between the hydrocarbon and water interface. The decreased interaction may lower the interfacial tension of the mixture and provide a fluid that is more mobile.

In a further aspect, the invention provides a hydrocarbon containing composition produced from a hydrocarbon containing formation, which comprises hydrocarbons and a hydrocarbon recovery composition according to the present invention.

Preferably, the hydrocarbon containing composition of the invention, is a hydrocarbon containing composition which has been produced from the hydrocarbon containing formation by means of the method for treating a hydrocarbon contains formation according to the present invention.

1. A hydrocarbon recovery composition, which composition contains:
a) a first anionic surfactant which is selected from the group consisting of a propoxylated primary alcohol carboxylate and propoxylated primary alcohol glycerol sulfonate, having a branched aliphatic group, which group has an average carbon number of in the range of from 8 to 30 and an average number of branches in the range of from 0.5 to 3.5, and having an average in the range of from 1 to 20 mole of propylene oxide groups per mole of primary alcohol; and
b) a second anionic surfactant which is an alkoxylated primary alcohol carboxylate or an alkoxylated primary alcohol glycerol sulfonate selected from the group consisting of (i) an ethoxylated primary alcohol carboxylate, (ii) an ethoxylated-propoxylated primary alcohol carboxylate, (iii) an ethoxylated primary alcohol glycerol sulfonate and (iv) an ethoxylated-propoxylated primary alcohol glycerol sulfonate, the alkoxylated primary alcohol carboxylate or alkoxylated primary glycerol sulfonate having a branched aliphatic group, which group has an average carbon number of in the range of from 8 to 30 and an average number of branches in the range of from 0.5 to 3.5, and having an average in the range of from 1 to 20 mole of alkylene oxide groups per mole of primary alcohol.

2. A hydrocarbon recovery composition according to claim 1, wherein the composition contains the first and the second anionic surfactant in a weight ratio of the first to the second anionic surfactant is in the range of from 90:10 to 30:70.

3. A hydrocarbon recovery composition according to claim 1, wherein the propoxylated primary alcohol carboxylate or propoxylated primary alcohol glycerol sulfonate of the first anionic surfactant has an average in the range of from 3 to 17 moles of propylene oxide groups per mole of primary alcohol.

4. A hydrocarbon recovery composition according to claim 1, wherein the aliphatic group of the propoxylated primary alcohol carboxylate or propoxylated primary alcohol glycerol sulfonate of the first anionic surfactant has an average carbon number of in the range of from 10 to 20, preferably of from 12 to 17.

5. A hydrocarbon recovery composition according to claim 1, wherein alkoxylated primary alcohol carboxylate or alkoxylated primary alcohol glycerol sulfonate of the second anionic surfactant has an average in the range of from 4 to 17 moles of alkylene oxide groups per mole of primary alcohol.

6. A hydrocarbon recovery composition according to claim 1, wherein the aliphatic group of the alkoxylated primary alcohol carboxylate or alkoxylated primary alcohol glycerol sulfonate of the second anionic surfactant has an average carbon number of in the range of from 11 to 17.

7. A hydrocarbon recovery composition according to claim 1, wherein the second anionic surfactant is an ethoxylated-propoxylated primary alcohol carboxylate or ethoxylated-propoxylated primary alcohol glycerol sulfonate.

8. A hydrocarbon recovery composition according to claim 1, wherein the branched aliphatic groups of the propoxylated primary alcohol carboxylate or propoxylated primary alcohol glycerol sulfonate of the first anionic surfactant and the alkoxylated primary alcohol carboxylate or alkoxylated primary alcohol glycerol sulfonate of the second anionic surfactant alkoxylated primary alcohol of the first and the second anionic surfactant have an average number of branches in the range of from 0.7 to 3.5.

9. An injectable liquid comprising a hydrocarbon recovery composition according to claim 1 dissolved in an aqueous brine, the brine having a salinity of at least 2 wt % and a hardness of at least 0.01 wt %, wherein the injectable liquid contains in the range of from 0.01 to 3.0 wt % of the first and second anionic surfactant.

10. An injectable liquid according to claim 9, containing in the range of from 0.2 to 1.0 wt % of the first and the second anionic surfactant.

11. An injectable liquid according to claim 9, wherein the brine has a salinity of at least 3 wt %.

12. An injectable liquid according to claim 11, wherein the brine has a salinity of at least 5 wt %.

13. An injectable liquid according to claim 9, wherein the brine has a hardness of at least 0.5 wt %.

14. An injectable liquid according to claim 14, wherein the brine has a hardness of at least 1.0 wt %.

15. An injectable liquid according to claim 9, wherein the brine comprises at least one of seawater or reservoir production water.

16. An injectable liquid according to claim 9, wherein the injectable liquid contains no more than one liquid phase.

17. A method of treating hydrocarbon containing formations, comprising:
(a) providing a hydrocarbon recovery composition according to claim 1 to at least a portion of a hydrocarbon containing formation; and
(b) allowing the composition to interact with hydrocarbons in the hydrocarbon containing formation.

18. A method according to claim 17, wherein the hydrocarbon recovery composition is provided to the hydrocarbon containing formation as part of an injectable liquid.

19. A method according to claim 18, wherein the injectable liquid contains reservoir production water.

20. A hydrocarbon containing composition produced from a hydrocarbon containing formation, which comprises hydrocarbons and a hydrocarbon recovery composition according to claim 1.

21. The hydrocarbon containing composition of claim 20, which has been produced from the hydrocarbon containing formation by means of the method.
